(19) United States
(12) Patent Application Publication
(10) Pub. No.: US 2018/0213588 A1
(43) Pub. Date: Jul. 26, 2018

(54) METHOD FOR DEVICE-TO-DEVICE RELAY PROCEDURE

(71) Applicant: Sharp Kabushiki Kaisha, Sakai City, Osaka (JP)

(72) Inventors: Xusheng WEI, Staines (GB); Shohei YAMADA, Sakai City (JP)

(21) Appl. No.: 15/747,201

(22) PCT Filed: May 25, 2016
(86) PCT No.: PCT/JP2016/002533

§ 371 Date: Jan. 24, 2018

Related U.S. Application Data
(60) Provisional application No. 62/198,166, filed on Jul. 29, 2015.

(51) Int. Cl. H04W 76/20; H04W 48/14; H04W 88/04; H04W 76/10

(52) U.S. Cl. CPC H04W 76/20; H04W 48/14; H04W 92/18; H04W 76/10; H04W 88/04

(57) ABSTRACT

A method performed by a user equipment (UE), the method comprising: receiving a Radio Resource Control (RRC) message including a first configuration for the UE to configure a sidelink relay operation; and broadcasting a master information block sidelink (MasterInformationBlock-SL) including a second configuration that indicates that the UE performs the sidelink relay operation.

### TECHNICAL FIELD

The present invention relates to sidelink relay operations in wireless communications, and more specifically to a mechanism for a Relay indication transmission procedure or a Sidelink User Equipment (UE) information transmission procedure related to a sidelink Relay operation.

### BACKGROUND ART

Proximity-based Services (ProSe) or Device-to-Device (D2D) services, which will enable devices to communicate each other directly, will provide valuable service for both public safety and non-public safety purposes. The benefits of D2D include, but are not limited to, improving the spectrum efficiency and overall throughput, reducing terminal's power consumption and providing a new type of peer to peer services.

Typical D2D applications include, but are not limited to, public safety, network offloading, etc. Additionally, D2D communication is one of the key features of 3GPP Release 12. In 3GPP Release 12, D2D has standardized support for a subset of features including:
ProSe device to device discovery in network coverage.
ProSe device to device broadcast communication.
Higher layer (AS layer) support to enable group-cast and uni-cast over physical layer broadcast communication.

Additionally, D2D will continue its evolution in a 3GPP Release 13 time frame. As discussed in RP-150441, “Revised WI: Enhanced LTE Device to Device Proximity Services”, Qualcomm Inc., main targets for D2D service in 3GPP Release 13 include:
(1) Support for D2D discovery in presence of multiple carriers and PLMNs; and
(2) Support for the extension of network coverage using L3-based UE-to-Network Relays, including service continuity, based on Release 12 D2D communication, considering applicability to voice and video.

A further use of D2D is to provide a D2D relay in which an out of coverage UE (e.g., a remote UE) transmits and receives signals to/from an eNB through a relay UE. The procedure to decide which UE can act as a relay UE has not been determined in 3GPP. However a procedure based on eNB control is a reasonable solution and has been proposed in, such as, for example, in R2-152185, “Considerations on relay selection and reselection”, Fujitsu. Additionally, in R2-152468, “Considerations on Relay initiation”, HuaWei, it was proposed that two thresholds, RSRP ThreshHigh and ThreshLow could be broadcasted by eNB. If the RSRP of a particular relay UE candidate satisfies ThreshLow<RSRP<ThreshHigh, this UE relay candidate can act as a UE relay and has either Model A or Model B discovery solutions. Model A and Model B discovery solutions, defined in 3GPP TR 23.713 V1.1.0, “Study on extended architecture support for proximity-based services”, are copied here for reference:
A. Model A uses a single discovery protocol message (Announcement)
B. Model B uses two discovery protocol messages (Solicitation and Response).

### SUMMARY OF INVENTION

### Technical Problem

The basic concept of the D2D relay is shown in FIG. 1 where an out of coverage UE (e.g., a remote UE) transmits and receives signals to/from an eNB through a relay UE. From the service continuity point of view, it has been agreed that even an in coverage UE can select a relay UE. However, a problem which was extensively studied is how to perform the relay UE selection/reselection. Similarly to cell selection/reselection, under normal situations, there will be a few relay UE candidates where a remote UE can choose to camp on. However, a method for determining how to select the most suitable relay UE is required. Further, when the environment of a remote UE is changed, the remote UE may want to execute a relay UE reselection procedure to camp on another relay UE which possesses good conditions, such as, for example, better radio conditions.

The above and other features, elements, characteristics, steps, and advantages of the present invention will become more apparent from the following detailed description of preferred embodiments of the present invention with reference to the attached drawings.

### Solution to Problem

According to the present invention, there is provided a method performed by a user equipment (UE), the method comprising: receiving a Radio Resource Control (RRC) message including a first configuration for the UE to configure a sidelink relay operation; and broadcasting a master information block sidelink (MasterInformationBlock-SL) including a second configuration that indicates that the UE performs the sidelink relay operation.

According to the present invention, there is provided another method performed by an evolved NodeB (eNB), the method comprising: transmitting a Radio Resource Control (RRC) message including a first configuration for a user equipment (UE) to configure a sidelink relay operation, wherein the first configuration causes the UE broadcasting a master information block sidelink (MasterInformationBlock-SL) including a second configuration that indicates that the UE performs the sidelink relay operation.

### BRIEF DESCRIPTION OF DRAWINGS

FIG. 1 is a diagram depicting a remote UE and a relay UE in accordance with a preferred embodiment of the present invention.

FIG. 2 is a block diagram of a UE relay release procedure in accordance with a preferred embodiment of the present invention.

FIG. 2a is a block diagram of another example of a UE relay request and relay release procedure in accordance with a preferred embodiment of the present invention.

FIG. 2b is a block diagram of yet another example of a UE relay request and relay release procedure in accordance with a preferred embodiment of the present invention.

FIG. 3 is a block diagram of a relay reconfiguration in accordance with a preferred embodiment of the present invention.

FIG. 4 is a block diagram of a UE in accordance with a preferred embodiment of the present invention.

FIG. 5 is a block diagram of an eNodeB in accordance with a preferred embodiment of the present invention.

### DESCRIPTION OF EMBODIMENTS

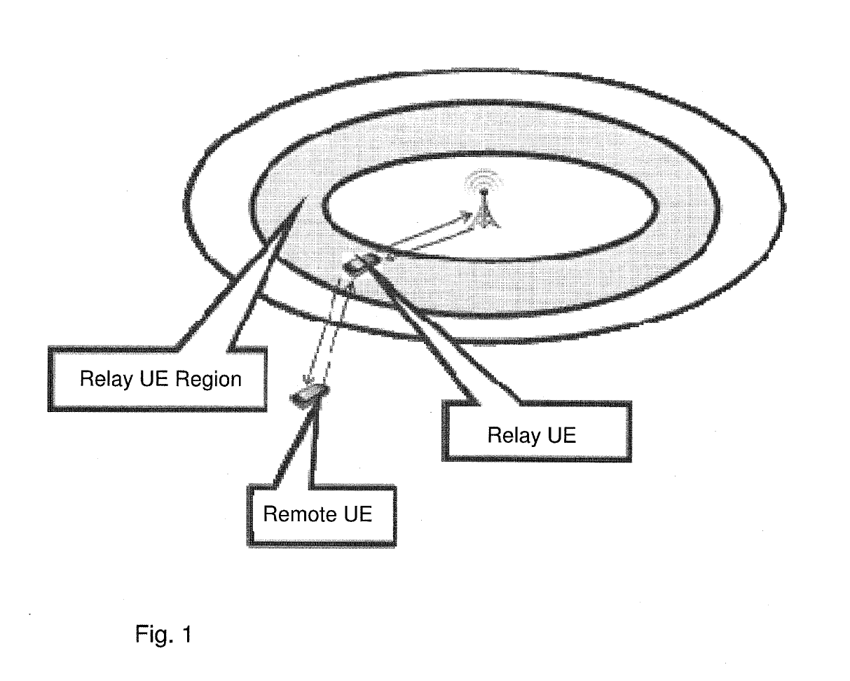

Preferred embodiments of the present invention correspond to discovering efficient manners for providing a mechanism for a relay indication transmission procedure or a sidelink UE information transmission procedure related to a sidelink Relay operation. In accordance with these mechanisms and procedures, choosing which UE can act as a relay UE could be determined by an eNB, and one logical conclusion is that the relay UE being selected should not be a UE at the cell edge, since the quality of the radio link at the cell edge is typically not as good as the quality of the radio link located within the middle of the cell. On the other hand, a cell center UE is also not a preferred UE to be used as a relay UE because, under that scenario, a better solution would be to let the UE communicate with its serving eNB directly. Accordingly, an optimal position for locating a relay UE region in accordance with the aforementioned reasons is shown in FIG. 1.

Although there has been some studying of the relay UE selection/reselection issue, the relay UE release procedure (i.e., a procedure which determines when and how to stop the relay function of a relay UE) which would result in ensuring that any remote UE camping on a relay UE would not be able to continue the camping for an unrestrained amount of time, has not attracted a lot of attention.

However, it has been discovered that a UE relay release mechanism is a necessity in some of the following user cases:
(1) Release procedure triggered by remote UE:
   In one typical user case, a UE moves from out of a coverage area to the cell center area. Once this happens, there is no longer any reason to maintain the relay link since, from the performance point of view, it is inefficient for the UE to depend on the relay link when the UE can provide its own link, and an unnecessary load will also be applied on the relay UE.
(2) Release procedure triggered/controlled by eNB:
   a. Based on existing measurement reports
   b. Based on additional UE information
      i. A few user cases can be identified for this scenario; (a) a relay UE moves close to the cell center; (b) a relay UE moves to the cell edge area or out of coverage area; (c) the relay UE indicates it does not want to act as a relay UE anymore; and (d) the serving eNB notify a relay UE to stop the relay service.

Details of preferred embodiments of a mechanism for a relay indication transmission procedure or Sidelink UE information transmission procedure related to a sidelink relay operation will now be described. The preferred embodiments of the present invention are able to ensure efficient performance of a sidelink relay operation. The preferred embodiments of the present invention may also be able to ensure that a UE relay is neither very close to the cell center nor at the cell edge through the use of, for example, two thresholds, RSRP ThreshHigh and ThreshLow which can be broadcasted by eNB. If the RSRP of a particular relay UE candidate satisfies ThreshLow<RSRP<ThreshHigh, this UE relay candidate can act as a UE. Together the higher threshold and lower threshold can be used to define a region where a relay UE locates. However, there is another issue to consider: how to determine the conditions to trigger UE relay release when radio conditions are deteriorated.

A method performed by a user equipment (UE) is described, The method includes receiving a Radio Resource Control (RRC) message including a first configuration (e.g., sl-RelayConfig) for the UE to configure a sidelink relay operation, and broadcasting a master information block sidelink (MasterInformationBlock-SL) including a second configuration (e.g., Relay-r13) that indicates that the UE performs the sidelink relay operation. The method may further include transmitting a RRC message including a relay release request related to whether the UE is releasing the relay operation in a cast that the UE is configured with the relay operation based on the configuration. The method may further include transmitting a RRC message including a relay request related to whether the UE is interested in establishing the relay operation.

A method performed by a evolved NodeB (eNB) is described. The method include transmitting a Radio Resource Control (RRC) message including a first configuration for a user equipment (UE) to configure a sidelink relay operation. The first configuration causes the UE broadcasting a master information block sidelink (MasterInformationBlock-SL) including a second configuration that indicates that the UE performs the sidelink relay operation. The method may further include receiving a RRC message including a relay release request related to whether the UE is releasing the relay operation in a cast that the UE is configured with the relay operation based on the configuration. The method may further include receiving a RRC message including a relay request related to whether the UE is interested in establishing the relay operation.

The proposed solution may be based on both thresholds and a timer. These thresholds may be either broadcasted to the whole cell or signaled to a particular relay UE through RRC signaling and a timer is used to avoid ping-pong issues so that the timer prevents the UE changing a behavior due to crossing thresholds in short times. In detail, one preferred embodiment of the present invention includes a situation in which a RRC_IDLE state UE asks to receive a connection to act as a relay when it finds it can be a relay based on thresholds. After that UE enters into RRC_CONNECTED states, where it will use both thresholds and timers to control its relay operation.

PC5 interface is an interface between UEs which is realized by sidelink. The sidelink may include ProSe Direct Discovery (e.g., sidelink direct discovery announcement) and/or ProSe Direct Communication (e.g., sidelink direct communication) between UEs (e.g. D2D). Sidelink may use uplink resources and physical channel structure similar to uplink transmissions. ProSe Direct Communication is a mode of communication whereby UEs can communicate with each other directly over the PC5 interface. ProSe Direct Discovery is defined as the procedure used by the UE supporting ProSe Direct Discovery to discover other UE(s) in its proximity, using EUTRA direct radio signals via PC5.

In order to perform synchronization for out of coverage operation UE(s) may act as a synchronization source by transmitting Sidelink Broadcast Control Channel (SBCCH) and a synchronization signal. SBCCH carries the most essential system information needed to receive other ProSe channels and signals. SBCCH along with a synchronization signal is transmitted with a fixed periodicity of 40 ms. When the UE is in network coverage, the contents of SBCCH are derived from the parameters signaled by the eNB. When the UE is out of coverage, if the UE selects another UE as a synchronization reference, then the content of SBCCH is derived from the received SBCCH; otherwise UE uses pre-configured parameters. SIB18 (SystemInformationBlockType18) provides the resource information for a synchronization signal and SBCCH transmission.

In order to perform synchronization UE(s) participating in announcing of discovery messages may act as a synchronization source by transmitting a synchronization signal based on the resource information for synchronization signals provided in SIB19.

There are three range classes. Upper layer authorization provides applicable range class of the UE. Maximum allowed transmission power for each range class is signaled in SIB19. UE uses the applicable maximum allowed transmission power corresponding to its authorized range class. This puts an upper limit on the determined transmit power based on open loop power control parameters. The eNB may provide a resource pool for UE autonomous resource selection based discovery message announcement in SIB 19 (SystemInforamtionBlockType19). UEs that are authorized for Prose Direct Discovery use these resources for announcing discovery message in RRC_IDLE. The eNB may indicate in SIB 19 that it supports ProSe Direct Discovery but does not provide resources for discovery message announcement. UEs need to enter RRC_CONNECTED in order to request resources for discovery message announcement.

A (Sidelink) Relay request may be transmitted to the eNB based on RSRP of the PCell. The Relay request may be related to whether the UE is interested in establishing a relay operation. The Relay request may, for example, be included in Sidelink UE information. Alternatively, the Relay request may be included in a Relay Indication. Differences between the implementations using the Relay request and the Sidelink UE information will be described below.

For one example, the upper layers may configure the UE to transmit a Relay request. The upper layers may initiate the RRC connection for the sidelink direct communication based on RSRP of the PCell and SIB18 and/or for the sidelink direct discovery based on RSRP of the PCell and SIB19. The procedure of transmission of sidelink UE information including a Relay request or the procedure of transmission of Relay Indication including a Relay request may be initiated following the RRC connection establishment procedure. For another example, the RRC may configure to transmit a Relay request. The upper layers initiate an RRC connection for sidelink direct communication based on SIB18 and/or for sidelink direct discovery announcement based on SIB19. The procedure of transmission of sidelink UE information including a Relay request or the procedure of transmission of Relay Indication including a Relay request may be initiated based on RSRP of the PCell and SIB18 and/or SIB19.

A (Sidelink) Relay Release request may be transmitted to the eNB based on RSRP of the PCell. The Relay Release request may be related to whether the UE is interested in or releasing the relay operation. The Relay Release request may be included in Sidelink UE information. Alternatively, the Relay Release request may be included in Relay Indication. For one example, the upper layers may configure the UE to transmit a Relay Release request. For another example, the procedure of transmission of sidelink UE information including a Relay Release request or the procedure of transmission of Relay Indication including a Relay Release request may be initiated based on RSRP of the PCell and SIB18 and/or SIB19.

Detailed conditions for transmission of Relay request or Relay Release request based on RSRP of the PCell preferably include the following examples. Regarding the settings of these thresholds and how to trigger the procedure, there are a few alternatives:
I. One way is to reuse the threshold defined before and combine with a timer (i.e., a UE relay can start a timer when either RSRP<ThreshLow or RSRP>ThreshHigh). After the timer expires, if the condition still holds, the relay release procedure can be triggered.
II. Alternatively, independent thresholds either based on RSRP or RSRQ can be defined, for example RSRP_{Low}_{_}_{Rel}; RSRQ_{Low}_{_}_{Rel}; RSRP_{High}_{_}_{Rel}; RSRQ_{High}_{_}_{Rel}. Up to implementation, a timer will start when RSRP<RSRP_{Low}_{_}_{Rel}/RSRP>RSRP_{High}_{_}_{Rel} or when RSRQ<RSRQ_{Low}_{_}_{Rel}/RSRQ>RSRQ_{High}_{_}_{Rel} or even both conditions described above are satisfied. After the expiry of that timer, if the condition still holds, the relay release procedure will be triggered.
III. Further, it is also possible to jointly consider the radio link quality of the sidelink and PC5 interface. Two thresholds can be defined where similar to RSRP_{Low}_{_}_{Rel}; RSRQ_{Low}_{_}_{Rel}, the first threshold (ThreshLow_sidelink) provides the minimum RSRP/RSRQ requirement for the sidelink. The second threshold (ThreshLow_pc5) provides the minimum requirement on the radio link quality measurement over PC5 (for example RSRP measurement). A relay UE can trigger the release procedure when its RSRP<ThreshLow_sidelink after the corresponding timer expires. Alternative after the expiry of the corresponding timer, a release procedure can be triggered by a relay UE when: Satisfying either of above conditions a/b means that, even when radio conditions of a relay UE is good (which means the relay UE is neither at the cell edge and nor close to the cell center), very few remote UEs will camp on this relay UE since the PC5 link quality is not good. Hence it is better to stop the relay service provided by this relay UE and find a suitable relay UE candidate to provide relay service, especially for the scenario where there is a limitation on the total number of relay UE per cell.
   a. the number of PC5 measurement (measured by relay UE or reported by remote UEs) less than the second threshold exceed a predefined/preconfigured value; or
   b. the number of PC5 measurement (measured by relay UE or reported by remote UEs) less than the second threshold exceed a predefined/preconfigured percentage
   Note: Due to the reciprocal of physical channel at PC5 interface, the measurement can be performed by relay UE or remote UE, the difference in measurement depends on the time variation of channel.
   Satisfying either of above conditions a/b means that, even when radio conditions of a relay UE is good (which means the relay UE is neither at the cell edge and nor close to the cell center), very few remote UEs will camp on this relay UE since the PC5 link quality is not good. Hence it is better to stop the relay service provided by this relay UE and find a suitable relay UE candidate to provide relay service, especially for the scenario where there is a limitation on the total number of relay UE per cell.
      In the above cases I-III, it is possible to use a timer value of 0, which means a timer is not used in the corresponding procedure.

Next, specific details of preferred embodiments of signaling procedures of relay UEs will be discussed. As mentioned above, the eNB could update thresholds which are used by a particular relay UE or could instead broadcast new thresholds over the cell, which implies that some relay UEs may trigger the relay UE release procedure after obtaining new thresholds.

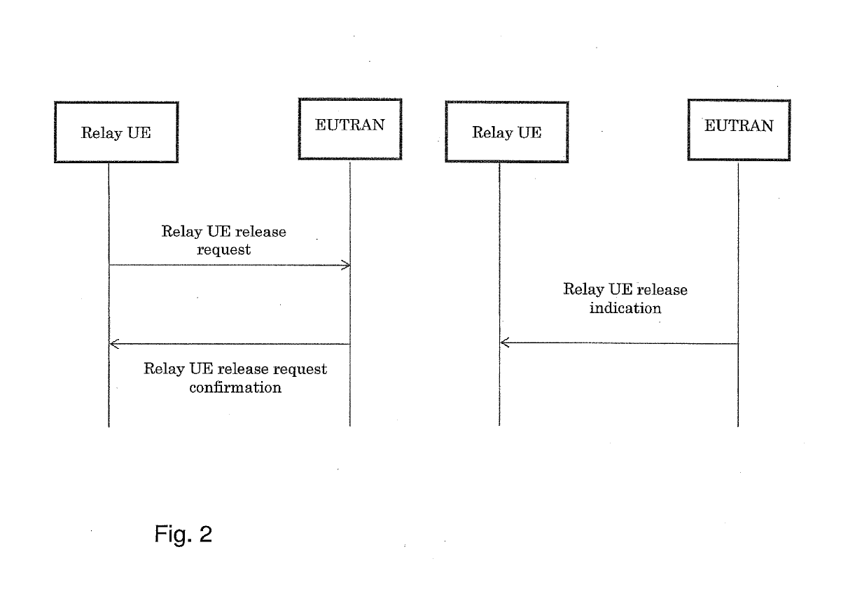

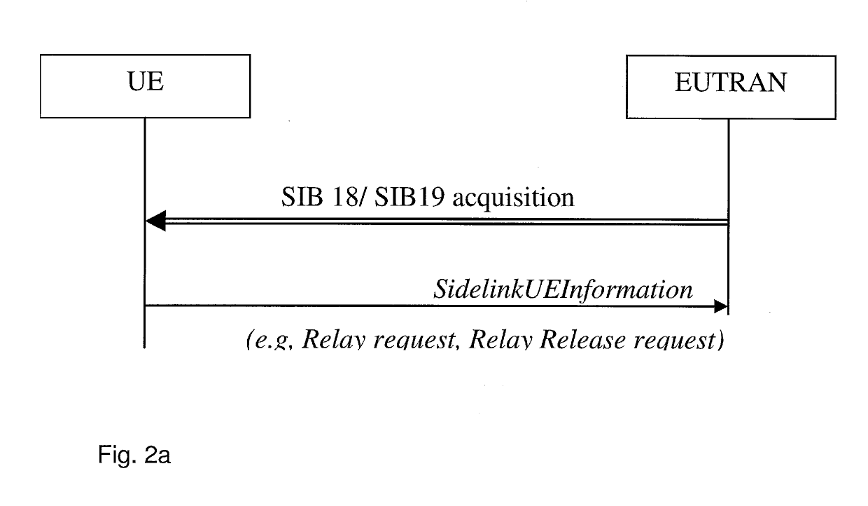

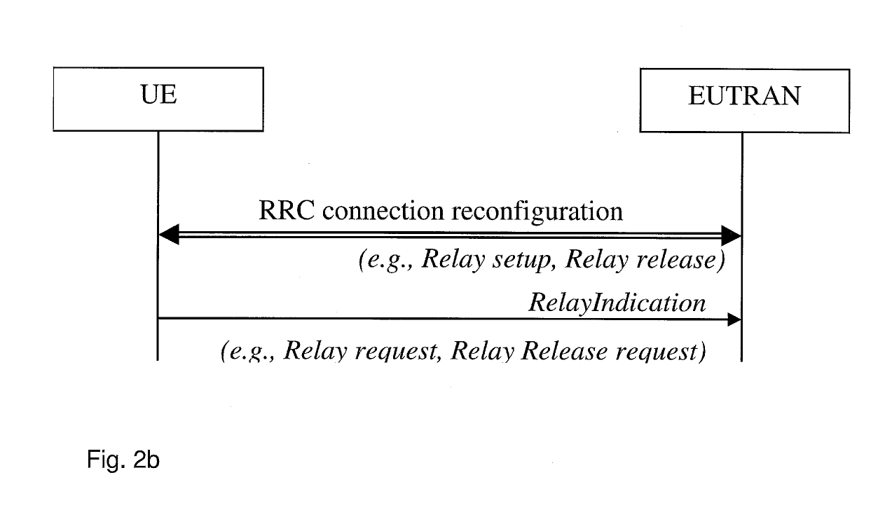

Below, the concrete implementation on how to realize the sidelink relay operation (e.g., Relay request/establish procedure, Relay release procedure) will be discussed. As shown in FIG. 2, two types of relay UE release procedures are illustrated. At the left hand side of FIG. 2, the UE relay release is triggered by relay UE, as described above. At the right hand side of FIG. 2, the relay UE release is conducted by eNB directly.

In preferred embodiments of the present invention, a “relay UE release request” message could include an indicator, which shows that the corresponding UE does not want to be a relay UE anymore. In addition it could include further optional information such as specific details of the “reasons” which caused the UE to send “relay UE release” indicator. The reasons could be related to the performance load on the UE, for example. Inside the “relay UE release request confirmation” message, a confirmation on “relay UE release” preferably is provided. The message could further include optional/non-optional indicators such as indicators which inform relay UE to release any resource related to relay UE operation. For example, any transmission/reception resource/resource pools allocated for relay operation purpose could be released.

A “Relay UE release indication” message is preferably sent by eNB to a relay UE directly without any prior information from relay UE side. Similarly to “relay UE release request confirmation” message, the message has a “relay UE release” indicator and other optional/non-optional indicators to release the resource used for relay operation.

Signaling for Sidelink Relay operation (sidelink UE information basis) in accordance with preferred embodiments of the present invention will now be discussed. As shown in FIGS. 2a and 2b, examples for realizing Sidelink Relay operation configuration are provided. As shown in FIG. 2a, the signaling for “Relay request” and “Relay release request” may be based on release-12 sidelink UE information procedure, i.e., the information where a relay UE wants to start or stop the relay function is sent to eNB through sidelink UE information. One example of a preferred implementation can be found, in Section 5.10.2.2 of 3GPP TS 36.331, Radio Resource Control (RRC) Protocol specification, v12.5.0, which states as follows:

```
    A UE capable of sidelink direct communication or discovery may initiate the
procedure to request assignment of dedicated resources for the concerned sidelink direct
communication transmission or discovery announcements, or to indicate its interest in
acting as a relay UE or not.
Upon initiating the procedure, the UE shall:
    1> if SystemInformationBlockType19 is broadcast by the PCell:
    2> if configured by upper layers to receive sidelink direct discovery
announcements on a serving frequency or on one or more frequencies included in
discInterFreqList, if included in SystemInformationBlockType19:
    ...
    2> else
    ...
    2> if the UE is configured by upper layers to transmit sidelink direct discovery
announcements:
    ...
    2> else:
    ...
    2> if the UE is configured by upper layers to perform a sidelink relay operation:
    3> if the UE did not transmit a SidelinkUEInformation message since entering
RRC_CONNECTED state; or
    3> if since the last time the UE transmitted a SidelinkUEInformation message
the UE connected to a PCell not broadcasting SystemInformationBlockType19; or
    3> the last transmission of the SidelinkUEInformatin message did not include
sl- RelayRequest (e.g., the Relay Request):
    4> initiate transmission of the SidelinkUEInformation message to indicate the
sidelink relay operation required by the UE;
    ...
    2> else:
    3> if the last transmission of the SidelinkUEInformation message included sl-
RelayRequest (e.g., the Relay Request):
    4> initiate transmission of the SidelinkUEInformation message to indicate it
does no longer require the sidelink relay operation (e.g., the Relay Release Request);
```

The SidelinkUEInformation should be updated in order to send the relay release indication. One example implementation is described in Section 6.2.2 of 3GPP TS 36.331, Radio Resource Control (RRC) Protocol specification, v12.5.0, which states as follows:

SidelinkUEInformation Message

| | |
|---|---|
| -- ASN1START | |
| -- ASN1START | |
| SidelinkUEInformation-r12 ::= | SEQUENCE { |
| criticalExtensions | CHOICE { |

| | |
|---|---|
| cl | CHOICE { |

| | |
|---|---|
| sidelinkUEInformation-r12 | SidelinkUEInformation-r12- |

```
      IEs, spare3 NULL, spare2 NULL, spare1 NULL
    },
```

| | |
|---|---|
| criticalExtensionsFuture | SEQUENCE { } |
| } | |
| } | |
| SidelinkUEInformation-r12-IEs ::= | SEQUENCE { |

| | | |
|---|---|---|
| commRxInterestedFreq-r12 | ARFCN-ValueEUTRA-r9 | OPTIONAL, |
| commTxResourceReq-r12 | SL-CommTxResourceReq-r12 | OPTIONAL, |
| discRxInterest-r12 | ENUMERATED {true} | OPTIONAL, |
| discTxResourceReq-r12 | INTEGER (1..63) | OPTIONAL, |
| lateNonCriticalExtension | OCTET STRING | OPTIONAL, |

| | |
|---|---|
| nonCriticalExtension | SidelinkUEInformation-r13-IEs |
| OPTIONAL, | |
| } | |

| | |
|---|---|
| SidelinkUEInformation-r13-IEs ::= | SEQUENCE { |

=============================== Example 1 =================================

| | | |
|---|---|---|
| RelayRequest-r13 | ENUMERATED {true} | OPTIONAL, |

=============================== Example 2 =================================

| | | |
|---|---|---|
| relayRxInterest-r13 | ENUMERATED {true} | OPTIONAL, |

=============================== Example 3 =================================

| | | |
|---|---|---|
| relayRxInterest-r13 | ENUMERATED {true} | OPTIONAL, |
| relayTxResourceReq-r13 | INTEGER (1..63) | OPTIONAL, |

============================================================================

| | | |
|---|---|---|
| nonCriticalExtension | SEQUENCE { } | OPTIONAL, |
| } | | |
| SL-CommTxResourceReq-r12 ::= | SEQUENCE { | |
| carrierFreq-r12 | ARFCN-ValueEUTRA-r9 | OPTIONAL, |

| | |
|---|---|
| destinationInfoList-r12 | SL-DestinationInfoList-r12 |
| } | |
| SL-DestinationInfoList-r12 ::= | SEQUENCE (SIZE (1..maxSL-Dest-r12)) |

OF SL-DestinationIdentity-r12

| | |
|---|---|
| SL-DestinationIdentity-r12 ::= | BIT STRING (SIZE (24)) |
| -- ASN1STOP | |

Signalling for Sidelink Relay operation (Relay Indication basis) in accordance with preferred embodiments of the present invention will now be discussed. As shown in FIG. 2b, an example for configuring a UE relay operation configuration is illustrated. Here, the signaling for “Relay request” and “Relay Release request” may be based on the Sidelink Relay Indication procedure (i.e., the information where a relay UE wants to start or stop the relay function is sent to eNB through sidelink UE information). One example implementation in accordance with a preferred embodiment of the present invention includes the following sequence:

```
X Initiation
A UE capable of providing Sidelink Relay indications may initiate the procedure when it
is configured to provide Sidelink Relay indications and upon change of Sidelink Relay
related information.
Upon initiating the procedure, the UE shall:
  1> if configured to provide Sidelink Relay indications (e.g., configured with
    sl-RelayConfig):
    2> if the UE did not transmit a RelayIndication message since it was configured
      to provide Sidelink Relay indications:
      3> if the UE is configured by upper layers to perform as a sidelink relay
        operation:
        4> initiate transmission of the RelayIndication message;
    2> else:
      3> if the UE is no longer configured by upper layers to perform as a sidelink
        relay operation; or
      3> if the RelayRequest is different from the value indicated in the last
        transmitted RelayIndication message:
        4> initiate transmission of the RelayIndication message;
Xx Actions related to transmission of RelayIndication message
The UE shall set the contents of the RelayIndication message as follows:
  1> if the UE is configured by upper layers to perform as a sidelink relayoperation;
    and/or if condition A (see 3.2.4) is met:
    2> set RelayRequest to TRUE;
  1> else:
    2> if the UE is no longer configured by upper layers to perform as a sidelink relay
      operation; and/or if condition A is met:
      3> set RelayRequest to TRUE;
```

The UE shall submit the ‘RelayIndication’ message to lower layers for transmission.

The ‘RelayIndication’ should be updated in order to send the relay release indication. One example implementation is described below:

RelayIndication-r13-IEs ::= SEQUENCE {
============================= Example 1 =======================

| | | |
|---|---|---|
| RelayRequest-r13 | ENUMERATED {true} | OPTIONAL, |

============================= Example 2 =======================

| | | |
|---|---|---|
| relayRxInterest-r13 | ENUMERATED {true} | OPTIONAL, |

============================= Example 3 =======================

| | | |
|---|---|---|
| relayRxInterest-r13 | ENUMERATED {true} | OPTIONAL, |
| relayTxResourceReq-r13 | INTEGER (1..63) | OPTIONAL, |

================================================================

| | | |
|---|---|---|
| nonCriticalExtension | SEQUENCE { } | OPTIONAL, |
| } | | |

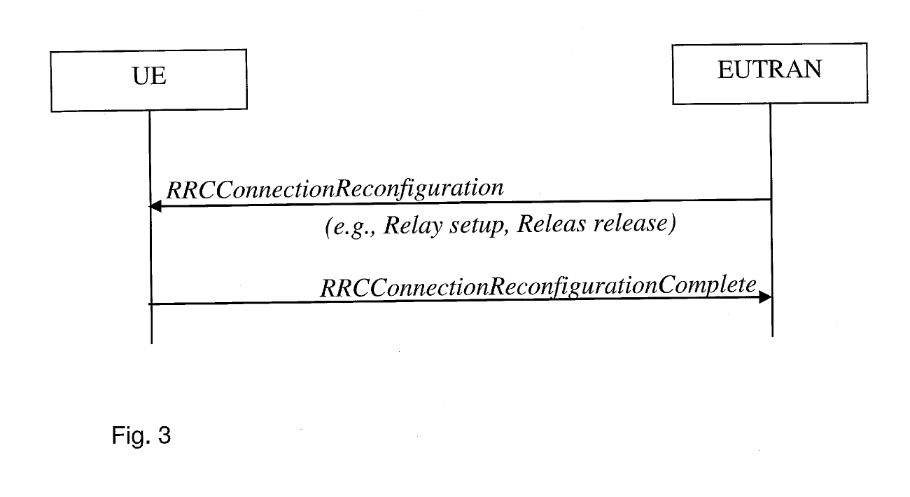

Signalling for Sidelink Relay reconfiguration in accordance with preferred embodiments of the present invention will now be discussed. As shown in FIG. 3, an example for (re)configuring a UE relay operation configuration in accordance with a preferred embodiment of the present invention is illustrated. The RRC signalling design in this section is based on the structure of Rel-12 “sidelink dedicated configuration”. One example implementation is illustrated below where a new IE sl-RelayConfig is introduced. This example implementation is described in Section 5.3.10.15 of 3GPP TS 36.331, Radio Resource Control (RRC) Protocol specification, v12.5.0, which states as follows:

```
          Sidelink dedicated configuration
    The UE shall:
    1> if the RRCConnectionReconfiguration message includes the
sl-CommConfig:
    ...
    1> if the RRCConnectionReconfiguration message includes the
sl-DiscConfig:
    2> if discTxResources is included and set to setup:
    ...
    2> else if discTxResources is included and set to release:
    ...
    1> if the RRCConnectionReconfiguration message includes the
sl-RelayConfig:
    2> if relayResources is included and set to setup:
    3> perform a procedure for transmission of
MasterInformationBlock-SL message; (e.g. with Relay-r13 set to TRUE)
    ...
    2> else ifrelayResources is included and set to release:
    3> from the next discovery/relay period, as defined by
discPeriod/relayPeriod, release the resources allocated for sidelink
relay previously configured by relayResources;
    3> perform a procedure for transmission of
MasterInformationBlock-SL message; (e.g, with Relay-r13 set to FALSE)
```

In the preferred embodiments of the present invention, the new IE introduced for relay operation (for example sl-RelayConfig) could include, for example, resource allocated for relay announcement signal transmission or resource for receiving signal from remote UE.

Signaling for Sidelink Relay UE status indication in accordance with preferred embodiments of the present invention will now be discussed. Besides the signaling between a relay UE and eNB designed in previous two sections, a relay UE could also indicate its relay status (Relay-r13) (whether the US is acting as a relay UE or not) through a MasterInformationBlock at the sidelink. This will help remote UE learn the current situation of relay UE. One example implementation based on section 5.10.7.4 of 3GPP TS 36.331, Radio Resource Control (RRC) Protocol specification, v12.5.0 is illustrated below:

```
========================= BEGIN ========================
5.10.7.4 Transmission of MasterInformationBlock-SL message
The UE shall set the contents of the MasterInformationBlock-SL message
as follows:
  1> if in coverage on the frequency used for sidelink direct
    communication, as defined in TS 36.304 [4, 11.4]:
    2> set inCoverage to TRUE;
    2> set sl-Bandwidth to the value of ul-Bandwidth as included in
      the received SystemInformationBlockType2 of the cell chosen for
      sidelink direct communication;
    2> if tdd-Config is included in the received
    SystemInformationBlockType1:
      3> set subframeAssignmentSL to the value representing the
      same meaning as of subframeAssignment that is included in
      tdd-Config in the received SystemInformationBlockType1;
    2> else:
      3> set subframeAssignmentSL to none;
    2> if sl-RelayConfig is configured;
      3> if condition A is met;
        4> set Relay-r13 to TRUE;
      3> else:
        4> set Relay-r13 to FALSE;
    2> else:
      3> set Relay-r13 to FALSE;
    2> if syncInfoReserved is included in an entry of commSyncConfig
      from the received SystemInformationBlockType18;
      3> set reserved to the value of syncInfoReserved in the received
        SystemInformationBlockType18;
    2> else:
      3> set all bits in reserved to 0;
  1> else if the UE has a selected SyncRef UE (as defined in 5.10.8):
    ...
  1> else (i.e. no SyncRef UE selected):
    ...
  1> set directFrameNumber and directSubframeNumber according to
  the subframe used to transmit the SLSS, as specified in 5.10.7.3;
  1> submit the MasterInformationBlock-SL message to
  lower layers for transmission upon which the procedure ends;
======================== = END =========================
```

The MasterinformationBlock-SL (section 6.5.2 of 3GPP TS 36.331, Radio Resource Control (RRC) Protocol specification, v12.5.0) should be updated and one example implementation is described below:

### MasterInformationBlock-SL

| | |
|---|---|
| -- ASN1START | |
| MasterInformationBlock-SL ::= | SEQUENCE { |

| | |
|---|---|
| sl-Bandwidth-r12 | ENUMERATED { |

n6, n15, n25, n50, n75, n100},

| | |
|---|---|
| tdd-ConfigSL-r12 | TDD-ConfigSL-r12, |
| directFrameNumber-r12 | BIT STRING (SIZE (10)), |
| directSubframeNumber-r12 | INTEGER (0..9), |
| inCoverage-r12 | BOOLEAN, |
| Relay-r13 | BOOLEAN |
| reserved-r12 | BIT STRING (SIZE (18)) |
| } | |
| -- ASN1STOP | |

In the above, the sl-RelayConfig indicates configurations for sidelink relay operation, which is included in a part of a RRC connection reconfiguration message. Relay-r13 indicates whether the UE can act as a relay (sidelink relay), which is broadcasted in MasterinformationBlock-SL. In the other words, the Relay-r13 may indicate whether the UE performs the sidelink relay operation. For example, the “condition A” above may not exist. UE sets Relay-r13 just based on whether sl-RelayConfig is configured or not. Then, broadcasting information whether the UE can act as a relay is controlled by the eNB. In the other words, the eNB may provide Relay-r13 and the UE may just set a value received by the RRC connection reconfiguration message to the Relay-r13. For another example, the “condition A” above may be ThreshLow<RSRP<ThreshHigh. For yet another example, the “condition A” above may be an expiry of a timer, where the timer starts when either RSRP<ThreshLow or RSRP>ThreshHigh. For yet another example, the “condition A” above may be that the UE is releasing the relay operation. It may be that the UE has performed the Relay Release request transmitting operation.

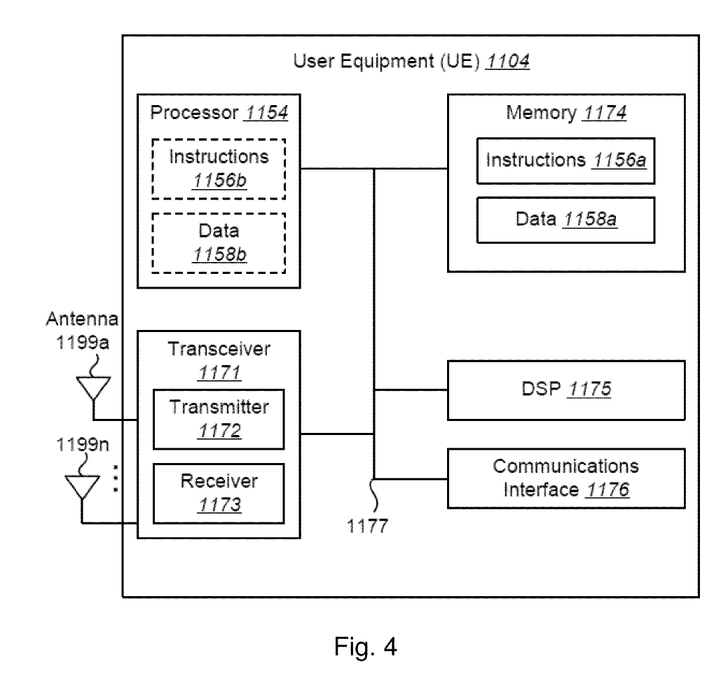

FIG. 4 illustrates various components that can be used in a UE 1104 in accordance with various preferred embodiments of the present invention. UE 1104 preferably includes a processor 1154 that is configured or programmed to control an operation of the UE 1104. The processor 1154 can also be referred to as a CPU or other similar device. Memory 1174, which can include read-only memory (ROM), random access memory (RAM), or any other device that can be used to store information, for example, provides instructions 1156a and data 1158a to the processor 1154. Memory 1174 can also include non-volatile random access memory (NVRAM), for example. Instructions 1156b and data 1158b can be used by the processor 1154. Instructions 1156b and/or data 1158b loaded into the processor 1154 can also include instructions 1156a and/or data 1158a from memory 1174 that were loaded for execution or processing by the processor 1154. The instructions 1156b are able to be executed by the processor 1154 to implement the systems and methods disclosed in this specification.

UE 1104 can also include a housing that contains a transmitter 1172 and a receiver 1173 which are configured to allow transmission and reception of data. The transmitter 1172 and receiver 1173 can be combined into a transceiver 1171, for example. One or more antennas 1199a-n are preferably attached to or enclosed within the housing and electrically coupled to the transceiver 1171.

The various components of UE 1104 are preferably coupled together by a bus system 1177, which can include a power bus, a control signal bus, and a status signal bus, in addition to a data bus, for example. However, for the sake of clarity, the various buses are illustrated in FIG. 4 as the bus system 1177. UE 1104 can also include a digital signal processor (DSP) 1175 configured or programmed to be used in processing signals. UE 1104 can also include a communications interface 1176 that provides user access to the functions of UE 1104. The UE 1104 illustrated in FIG. 4 is a functional block diagram rather than a listing of specific components.

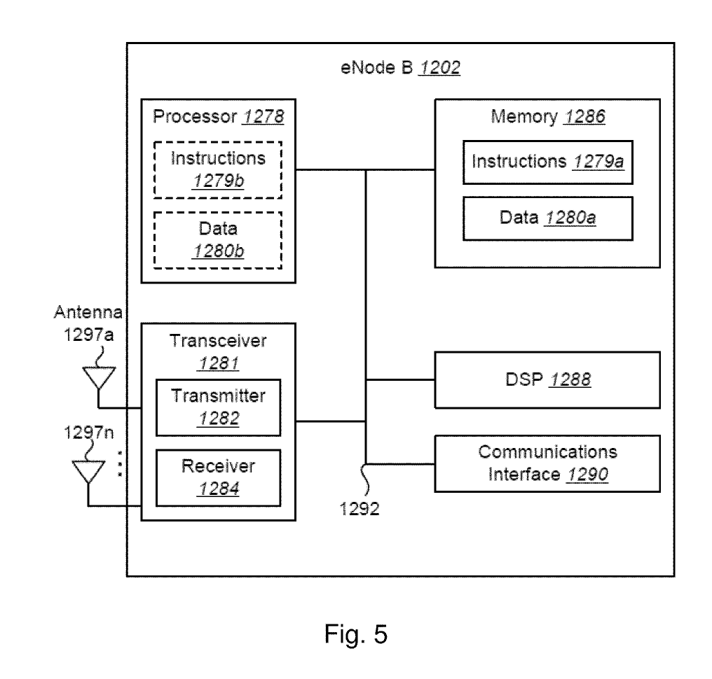

FIG. 5 illustrates various components that can be utilized in an eNodeB 1202 according to various preferred embodiments of the present invention. The eNodeB 1202 can include components that are similar to the components discussed above in relation to UE 1104, including a processor 1278, memory 1286 that is configured or programmed to provide instructions 1279a and data 1280a to the processor 1278, instructions 1279b and data 1280b that can reside in or be loaded into the processor 1278, a housing that contains a transmitter 1282 and a receiver 1284 (which can be combined into a transceiver 1281), one or more antennas 1297a-n electrically coupled to the transceiver 1281, a bus system 1292, a DSP 1288 for use in processing signals, a communications interface 1290 and so forth.

he functions described in this specification can be implemented in hardware, software, firmware, or any combination thereof. If implemented in software, the functions can be stored as one or more computer-executable or processor-executable instructions on a computer-readable medium. The term “computer-readable medium” refers to any available tangible, non-transitory medium that can be accessed by a computer or a processor. By way of example, and not limitation, a computer-readable or processor-readable medium can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used in this specification, includes compact disc (CD), laser disc, optical disc, digital versatile disc (DVD), floppy disk and Blu-ray (registered trademark) disc, where disks usually reproduce data magnetically, while discs reproduce data optically with lasers. If implemented in hardware, the functions described in this specification can be implemented in and/or realized using a chipset, an application-specific integrated circuit (ASIC), a large-scale integrated circuit (LSI), an integrated circuit, etc.

Each of the methods disclosed in this specification includes one or more steps or actions that achieve the described method. The method steps and/or actions can be interchanged with one another and/or combined into a single step without departing from the scope of the present invention. In other words, unless a specific order of steps or actions is required for proper operation of the method that is being described, the order and/or use of specific steps and/or actions can be modified without departing from the scope of the claims.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term “memory” can include various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is considered to be in electronic communication with a processor if the processor can read information from and/or write information to the memory. Memory can be integral with a processor and still be considered to be in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can be defined by or include a single computer-readable statement or many computer-readable statements.

It should be understood that the foregoing description is only illustrative of preferred embodiments of the present invention. Various alternatives and modifications can be devised by those skilled in the art without departing from the present invention. Accordingly, the present invention is intended to embrace all such alternatives, modifications, and variances that fall within the scope of the foregoing description.

With the preferred embodiments of the present invention described above, solutions for sidelink relay operations are provided. These solutions include mechanisms and procedures to perform the sidelink relay request/release procedure and the detailed implementation on how to realize sidelink relay procedure. The preferred embodiments provide various solutions to perform sidelink relay procedures. Preferred embodiments of the present invention and modifications thereof provide a mechanism to configure a relay operation, a mechanism to broadcast a relay indication by a Relay UE, and a mechanism to indicate an interest of a relay release or request from a Relay UE to an eNB.

1. A method performed by a user equipment (UE), the method comprising:
transmitting a Radio Resource Control (RRC) message including sidelink UE information in a case that the UE is configured by upper layer to perform a sidelink relay operation, wherein the sidelink UE information includes information indicating the UE acting as the sidelink relay.

2-6. (canceled)

7. A user equipment (UE), comprising:
a transmit circuit configured to transmit a Radio Resource Control (RRC) message including sidelink UE information in a case that the UE is configured by upper layer to perform a sidelink relay operation, wherein the sidelink UE information includes information indicating the UE acting as the sidelink relay.
